(19) United States
(12) Patent Application Publication
(10) Pub. No.: US 2016/0097680 A1
(43) Pub. Date: Apr. 7, 2016

(54) EQUIPMENT AND METHOD FOR ADVANCED IMAGING BURNER CONTROL PROCESS

(71) Applicant: Honeywell International, Inc., Morristown, NJ (US)

(72) Inventors: Stefano Bietto, Tulsa, OK (US); Kurt Kraus, Tulsa, OK (US); Matthew Martin, Tulsa, OK (US)

(21) Appl. No.: 14/508,435

(22) Filed: Oct. 7, 2014

(51) Int. Cl. G01J 5/00; G01J 5/02

(52) U.S. Cl. CPC G01J 5/0044; G01J 5/0018; G01J 5/025; G01J 2005/0077

(57) ABSTRACT

A process is provided for diagnosing conditions of a combustion process in an enclosure is provided, and includes steps of: capturing images of selected regions of the enclosure using a plurality of image-capturing devices connected to the enclosure; receiving a plurality of signals representing the conditions of the combustion process from at least one sensor associated with the enclosure; estimating a three-dimensional (3D) radiance or temperature field of the combustion process in the selected regions; evaluating the captured images, the plurality of signals, and the 3D radiance or temperature field for analyzing the conditions of the combustion process at a predetermined interval; and adjusting at least one furnace parameter based on the evaluation of the images, the plurality of signals, and the 3D radiance or temperature field for controlling the conditions of the combustion process in the enclosure.

The present invention relates generally to a process for diagnosing conditions of a combustion process, and more particularly to a process for an accurate analysis and a desired optimization of the conditions of the combustion process of a furnace enclosure using environment indications.

### BACKGROUND OF THE INVENTION

Accurately analyzing internal conditions of a furnace is an essential task for an operator to better control temperatures of different regions in a furnace enclosure for producing products more efficiently and saving energy-related costs. Image-capturing devices, such as color cameras, infrared spectrometers, filtered cameras, and the like, are installed in the furnace enclosure for detecting the temperatures of the furnace enclosure. Intensities of image pixels received from the devices have a direct relationship with the temperatures of viewed surfaces inside the furnace. Similarly, multi-spectral cameras have been used to detect the temperature of a flame and gas species.

A certain method of video-based technology provides color or intensity images to the operator allowing the operator to manually interpret the state of the combustion process based on the images. An exemplary intensity-temperature calibration and transformation are disclosed in commonly assigned U.S. patent application Ser. No. 14/306,063 (Attorney Docket No. H0044426-8228), which is incorporated by reference in its entirety. Another technology performs off-line intensity-temperature calibration and maps each color image to a specific temperature image, thereby providing a two-dimensional (2D) projection of the temperature and/or radiance field. Other technologies, such as laser, and acoustic, offer three-dimensional (3D) temperature and/or radiance field estimation at specific locations inside the furnace enclosure. However, a number of required sensors, a related cost, and a complicated installation often make such systems impractical in a large scale enclosure. An exemplary 3D temperature and/or radiance field estimation system and method are disclosed in commonly assigned U.S. patent application Ser. No. 14/296,265 (Attorney Docket No. H0041504-8228) and U.S. patent application Ser. No. 14/296,286 (Attorney Docket No. H0041508-8228), which are incorporated by reference in their entirety.

Another technology for video-based, three-dimensional temperature and/or radiance field estimation applies thermal radiation transfer equations to the temperature images. However, this method is inefficient and inaccurate, and does not provide a required resolution and accuracy due to complex, iterative computations required to resolve unknown temperature and radiance fields in the enclosure. Another reason for the inaccuracy is attributed to poor-quality images caused by incorrect or limited controls of the image-capturing devices. Achieving an acceptable accuracy in high resolution and accurate alignment of the images along with information about a physical structure of the enclosure is essential. As discussed above, relative positions of the image-capturing devices and imaging areas, such as enclosure walls, often shift their alignments and thus cause significant errors.

In a petrochemical and refinery field, the process and furnace conditions often change due to upstream conditions, sometimes in an uncontrollable manner. Environment parameters, such as a feed flow, a burner fuel flow, or a furnace draft, can drastically change in a short time period. As a result, the conditions in the furnace can change significantly. For example, changes in the flame shape can lead to increased production of carbon monoxide (CO) or NOx gases. Similarity, an increase in flame length can produce flame impingement in the process piping, undesirably changing the conditions for the chemical processes occurring therein. To maintain an optimal process condition and to operate in a desired manner, burner adjustments need to be performed when such conditions occur. For example, an air damper position can be adjusted manually by an operator on site. However, this operation can be time-consuming and expensive, and further delay current operation during the adjustments. Also, every regulation of the air damper is subjected to the judgment of the operator who often does not have the support of various data and measurements related to the furnace conditions, thereby causing inaccurate and ineffective adjustments.

Therefore, there is a need for an improved method of diagnosing conditions of the combustion process in the enclosure without generating substantial errors or variations during the burner adjustments. Further, the accurate analysis of the furnace conditions provides the operator a better tool to improve the efficiency of the furnace enclosure.

### BRIEF SUMMARY OF THE INVENTION

The present invention is directed to a process for diagnosing and optimizing conditions of a combustion process in a furnace enclosure based on environment indications. The environment indications include a set of multi-spectral images captured by a plurality of multi-spectral image-capturing devices, a plurality of signals representing the conditions of the combustion process, and a three-dimensional (3D) radiance or temperature field of the combustion process in selected regions of the furnace enclosure.

An important feature of the present invention is that the present process automatically regulates burner equipment by adjusting at least one furnace and/or burner parameter based on the captured images, the plurality of signals, and the 3D radiance or temperature field. The present process measures and indicates current conditions of the combustion process within the enclosure. Such information is used to selectively regulate the burner equipment by modulation or manipulation of input fuel sources, combustion air sources, or mechanical features of an associated burner or furnace based on indications from the images, the sensors, and the 3D radiance or temperature field.

In practice, the present process may be applied to any combustion enclosure, whose flames are generated by, for example, premix, diffusion mix, solid fuel, liquid fuel, and gaseous fuel used in industrial, residential, commercial, or power burners, flares, or thermal oxidizers. It is also contemplated that the present process may be used to validate and/or optimize indications resulting from computational models of physical systems. Specifically, in certain embodiments, the present process observes a physical enclosure, and corresponding computational model input parameters are adjusted to conform to the physical observations.

In one embodiment, a process for diagnosing conditions of a combustion process in an enclosure is provided, and includes steps of: capturing images of selected regions of the enclosure using a plurality of image-capturing devices connected to the enclosure; receiving a plurality of signals representing the conditions of the combustion process from at least one sensor associated with the enclosure; estimating a three-dimensional (3D) radiance or temperature field of the combustion process in the selected regions; evaluating the captured images, the plurality of signals, and the 3D radiance or temperature field for analyzing the conditions of the combustion process at a predetermined interval; and adjusting at least one furnace parameter based on the evaluation of the images, the plurality of signals, and the 3D radiance or temperature field for controlling the conditions of the combustion process in the enclosure.

In another embodiment, an apparatus for diagnosing conditions of a combustion process in an enclosure is provided, and includes an adjustment unit configured for: capturing images of selected regions of the enclosure using a plurality of image-capturing devices connected to the enclosure; receiving a plurality of signals representing the conditions of the combustion process from at least one sensor associated with the enclosure; estimating a three-dimensional (3D) radiance or temperature field of the combustion process in the selected regions; evaluating the captured images, the plurality of signals, and the 3D radiance or temperature field for analyzing the conditions of the combustion process at a predetermined interval; and adjusting at least one furnace parameter based on the evaluation of the images, the plurality of signals, and the 3D radiance or temperature field for controlling the conditions of the combustion process in the enclosure.

In yet another embodiment, a non-transitory computer-readable medium storing instructions executable by a computer processor to diagnose conditions of a combustion process in an enclosure is provided, and includes instructions to: capture images of selected regions of the enclosure using a plurality of image-capturing devices connected to the enclosure; receive a plurality of signals representing the conditions of the combustion process from at least one sensor associated with the enclosure; estimate a three-dimensional (3D) radiance or temperature field of the combustion process in the selected regions; evaluate the captured images, the plurality of signals, and the 3D radiance or temperature field for analyzing the conditions of the combustion process at a predetermined interval; and adjust at least one furnace parameter based on the evaluation of the images, the plurality of signals, and the 3D radiance or temperature field for controlling the conditions of the combustion process in the enclosure.

The foregoing and other aspects and features of the present invention will become apparent to those of reasonable skill in the art from the following detailed description, as considered in conjunction with the accompanying drawings.

### BRIEF DESCRIPTION OF THE DRAWINGS

FIG. 1 illustrates an exemplary use of the present process in a camera system configuration;

FIG. 2 is a functional block diagram of the present process featuring functional units in accordance with an embodiment of the present disclosure; and

FIG. 3 is a flow chart of the present process illustrating steps in accordance with an embodiment of the present disclosure.

10

### DETAILED DESCRIPTION OF THE INVENTION

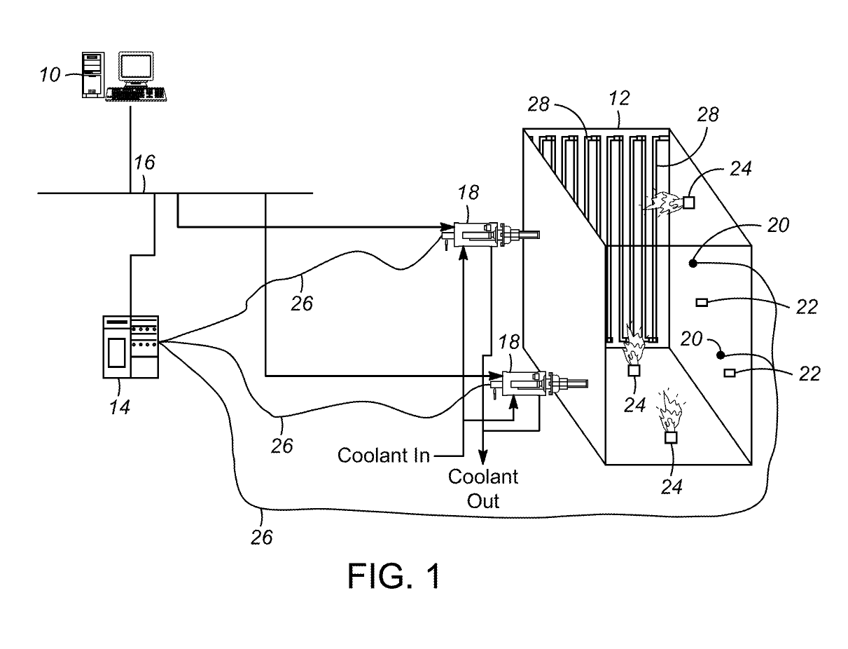

Referring now to FIG. 1, an exemplary adjustment unit 10 using an embodiment of the present process is provided for accurately analyzing conditions of a combustion process inside a large scale enclosure 12, such as an industrial furnace. As used herein, the term “unit” may refer to, be part of, or include an Application Specific Integrated Circuit (ASIC), an electronic circuit, a computer processor (shared, dedicated, or group) and/or memory (shared, dedicated, or group) that executes one or more software or firmware programs, a combinational logic circuit, and/or other suitable components that provide the described functionality. Thus, while this disclosure includes particular examples and arrangements of the units, the scope of the present process should not be so limited since other modifications will become apparent to the skilled practitioner.

The adjustment unit 10 is coupled to a server or computing device 14 (including, e.g., a database and video server), and is programmed to perform tasks and display relevant data for different functional units via a network 16. It is contemplated that other suitable networks can be used, such as a corporate Intranet, a local area network (LAN) or a wide area network (WAN), and the like, using dial-in connections, cable modems, high-speed ISDN lines, and other types of communication methods known in the art. All relevant information can be stored in the databases for retrieval by the adjustment unit 10 or the computing device 14 (e.g., as a data storage device and/or a machine readable data storage medium carrying computer programs).

A plurality of image-capturing devices 18 are mounted around the enclosure 12 (with two devices 18 being shown in this example, but with additional devices being included, if desired). The image-capturing devices 18 have the ability to capture the response in one or multiple parts of the electromagnetic spectrum including visible, ultra-violet, near infrared (NIR), mid wave infrared (MWIR) and long wave infrared (LWIR). The devices 18 can be configured to capture data in specific spectrum bands as required by detection of targeted gas species (e.g., detect presence of carbon monoxide). In addition, the devices 18 can be auto-configured to detect a specific range of temperatures or radiance field. Further, each of the image-capturing devices 18 can be individually configured for a specific spectrum band to increase the efficiency of the system and enable detection of multiple gas species in one or different regions of the enclosure 12. Each image-capturing device 18 can be liquid-cooled by directing the inflow of cold coolant CoolantIN to the device, and delivering the outflow of warm coolant CoolantOUT from device to an outlet.

Each of the image-capturing devices 18 captures image sequences covering a selected interior portion or region of the enclosure 12, for which a temperature-radiance field and gas species field are to be estimated. A plurality of temperature sensors 20, such as thermal couples or pyrometers, which are each observable by one or more image-capturing devices 18, are placed inside the enclosure 12. Optional markers 22, which are within a field of view (FOV) of the image-capturing devices 18, may also be placed inside the enclosure 12.

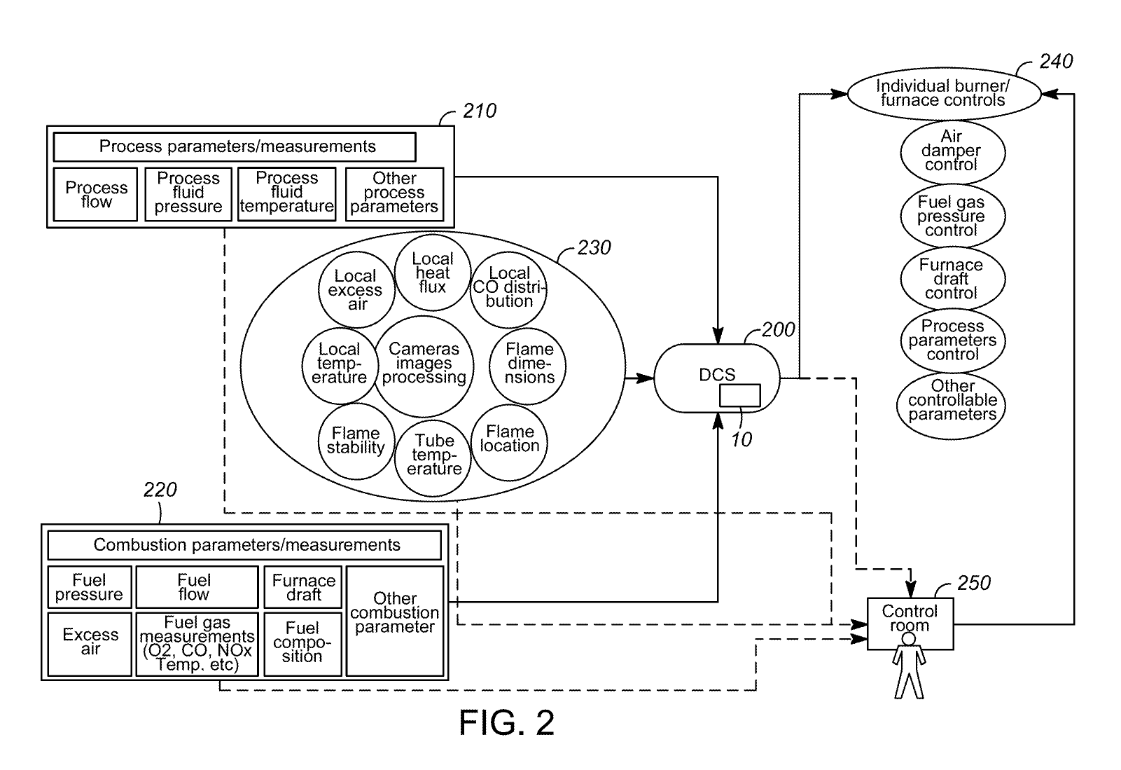

Other sensors and measuring instruments, such as a gas analyzer and a pressure transducer, are also contemplated to suit different applications. For example, an actuator is installed for an air damper associated with a burner 24, and a mechanical gas valve is disposed on an individual burner gas line associated with the burner 24. In a preferred embodiment, although three burners 24 are shown, any number of burners 24 are disposed and distributed throughout the enclosure 12. The other sensors and measuring instruments send signals to the adjustment unit 10, and the adjustment unit 10 evaluates the received signals for analyzing the conditions of the combustion process. The adjustment unit 10 adjusts at least one furnace parameter, such as an air damper position and a fuel pressure, based on the received signals. As described in greater detail below in paragraphs relating to FIG. 2, the furnace parameters include at least one of: a process parameter, a combustion parameter, and an image parameter.

Cables 26 (or other signal transferring means, such as wireless communication) connect the image-capturing devices 18 and the temperature sensors 20 to the computing device 14, which may also have digitization, storage, and user interface capabilities. The computing device 14 receives temperature outputs or signals from the temperature sensors 20 and image sequences from the image-capturing devices 18 to set proper parameters of the image-capturing devices for performing subsequent calibration, registration and estimating temperature-radiance field of the selected region.

It is an important task for an operator to optimally set the parameters related to the combustion process for maximum product yield, maximum energy efficiency, and minimum fuel gas consumed. Often, the operator selectively controls the combustion process based on a visual estimation of a state of the process at specific locations inside the enclosure 12. Acquiring the states of the process necessitates the knowledge of the three-dimensional temperature and radiance field inside the enclosure 12.

In one embodiment, three-dimensional temperature and/or radiance fields are computed from a set of images, which are captured by optimally placed image-capturing devices 18 in the enclosure 12.

As shown in FIG. 1, the plurality of image-capturing devices 18 are disposed in the enclosure 12, and the plurality of temperature sensors 20 are disposed at selected locations of the enclosure for collecting data. The adjustment unit 10 calculates and determines the temperature and radiance fields of the selected regions of the enclosure 12 based on the collected data. An exemplary three-dimensional radiance and gas species field estimation method is disclosed in commonly assigned U.S. patent application Ser. No. 14/296,265 (Attorney Docket No. H0041504.8228), which is incorporated by reference in its entirety. Further, an exemplary intensity-temperature transformation of imaging system is disclosed in commonly assigned U.S. patent application Ser. No. 14/296,286 (Attorney Docket No. H0041508-8228), which is incorporated by reference in its entirety.

In a preferred embodiment, the plurality of image-capturing devices 18 are strategically placed in the enclosure 12 to give accurate images of the flames produced by the burners. The image-capturing devices 18 measure the distance between the flames and the process piping 28, such that it is possible to evaluate (or detect) flame impingement and overheating of the process piping 28. In a preferred embodiment, computer software having one or more units collect all associated data (e.g., images, physical readings, etc.) and elaborate them, taking into account the furnace geometry. The enclosure 12 is preferably equipped with sensors and instruments, such as gas analyzers, pressure indicators, and thermal couples, for measuring excessive oxygen (02), unburned hydrocarbons, carbon monoxide (CO), vessel temperature, and vessel pressure. Other measurements, such as local temperatures in the enclosure 12 and on the process piping 28, fuel pressure, and the like are also contemplated to suit the application. All signals from these sensors and instruments are sent to the adjustment unit 10 for computing the amount of changes in the burner settings to optimize the burner operation.

Referring now to FIG. 2, a schematic flow diagram of the present apparatus having the adjustment unit 10 illustrates its high level processes and the outputs of each process. An exemplary distributed control system (DCS) 200 having the adjustment unit 10 is shown for illustrating flows of the present process. The DCS 200 receives furnace parameters or measurement values from at least one of an air damper position sensor, a fuel pressure sensor, a flapper position sensor, an oxygen sensor, a temperature sensor, a draft sensor, a pressure sensor, and the image-capturing device 18. Similarly, the DCS 200 receives burner parameters or measurement values from associated burners. As discussed above, the furnace and/or burner parameters include at least one of: a process parameter 210, a combustion parameter 220, and an image parameter 230.

More specifically, the process parameter 210 may include a process flow signal, a process fluid pressure signal, a process fluid temperature signal, and other process parameter signals. The combustion parameter 220 may include a fuel pressure signal, a fuel flow signal, a furnace draft signal, an excess air signal, a flue gas signal (e.g., O2, CO, NOx, gas temperature, etc.), a fuel composition signal, and other combustion parameter signals. The image parameter 230 may include a local heat flux signal, a local CO distribution signal, a flame dimension signal, a flame location signal, a tube temperature signal, a flame stability signal, a local temperature signal, a local excess air signal, and other camera image processing signals.

The DCS 200 generates an individual burner or furnace control signal 240 based on at least one of the process parameter 210, the combustion parameter 220, and the image parameter 230. The adjustment unit 10 of the DCS 200 adjusts at least one furnace parameter based on at least one of the received signals for controlling the conditions of the combustion process in the enclosure 12. As an example, a current pressure of fuel gas can be adjusted based on a predetermined amount of change in the fuel pressure signal received from the fuel pressure sensor during a predetermined time period. It is contemplated that a delta value representing the amount of change between a previous fuel pressure signal and a current fuel pressure signal may be used for adjusting the at least one furnace parameter using a closed-loop control feedback system.

As another example, the adjustment unit 10 increases an air opening for reducing the flame length and increasing an amount of oxygen to the burner. The adjustment unit 10 also reduces fuel pressure for shortening flame length of a burner and lowering the temperature in the furnace (i.e., reduction of burner heat output). An important aspect of the present invention is that the furnace settings are capable of being adjusted for each burner separately. Each flame is associated with a specific burner. Thus, the adjustment is preferably automatically performed by the adjustment unit 10 for each particular burner will be associated with a flame—although some adjustments may impact more than one burner/flame and/or all of the burners/flames. The images of each flame are used for assessing the operation of each burner. By controlling the burners individually and estimating the level of control by imaging the flames, the result can be a more refine and optimal operation when compared to conventional methods known in the art. As an alternative, a control room 250 is provided for an operator to manually perform the adjustment based on at least one of the parameters 210, 220, 230.

Similarly, a flapper position can be adjusted based on a flapper position signal from the flapper position sensor for changing flame shapes, and the air damper can be adjusted based on an air damper position signal from the air damper position sensor for opening and closing an air damper gate. In certain cases, a combination of two or more signals received from the plurality of sensors and measuring instruments is used to adjust at least one furnace components as discussed above. Although only a few furnace components are discussed herein, other similarly related components in different applications are also contemplated for the present process, such as a butterfly valve for controlling a draft flow, and a suction fan control system for removing flue gases.

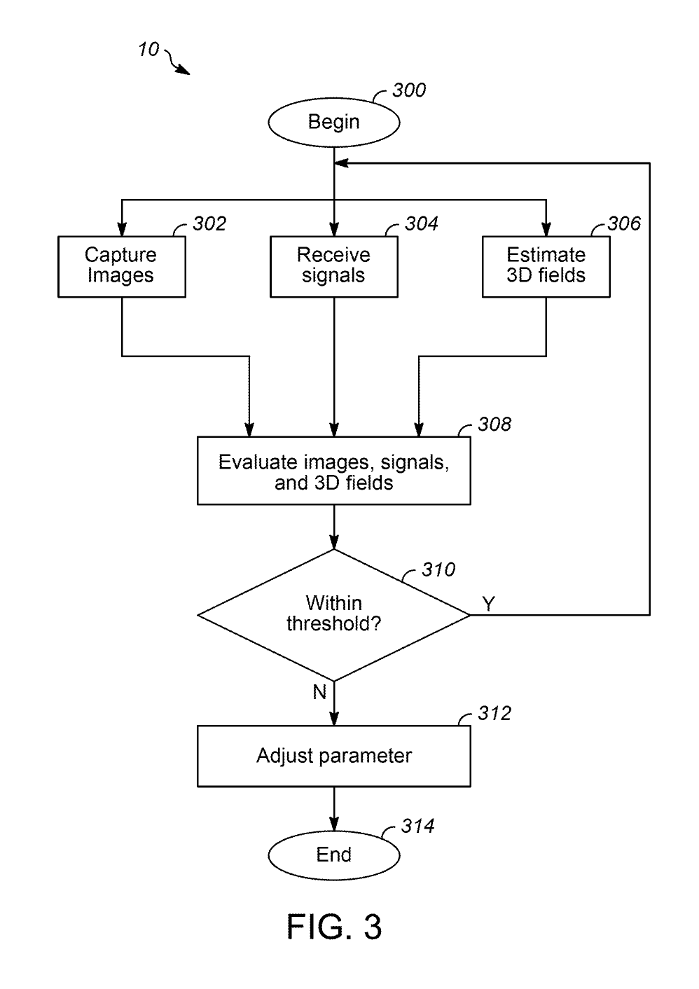

Referring now to FIG. 3, an exemplary flow chart of the present process is shown, illustrating the steps for diagnosing conditions of the combustion process in the enclosure 12. Although the following steps are primarily described with respect to the embodiment of FIGS. 1 and 2, it should be understood that the steps within the method may be modified and executed in a different order or sequence without altering the principles of the present disclosure.

As shown in FIG. 3, the process begins at step 300. In step 302, images of selected regions of the enclosure 12 are captured using a plurality of image-capturing devices 18 connected to the enclosure 12. In step 304, a plurality of signals is received representing the conditions of the combustion process from at least one sensor associated with the enclosure 12. In step 306, a three-dimensional (3D) radiance or temperature field of the combustion process in the selected regions is estimated. Each sensor detects an operational status of a corresponding component of the enclosure 12. Steps 302 through 306 may be simultaneously and separately performed by the adjustment unit 10, or alternatively, may be sequentially performed by subunits of the adjustment unit 10.

In step 308, the adjustment unit 10 evaluates the captured images, the plurality of signals, and the 3D radiance or temperature field for analyzing the conditions of the combustion process at a predetermined interval. For example, the adjustment unit 10 detects flame impingement or temperatures associated with components of the enclosure 12 based on at least one of: the captured images, the plurality of signals, and the 3D radiance or temperature field for determining which flame is operating in an acceptable condition.

In step 310, the adjustment unit 10 computes an amount of change in the at least one furnace parameter during a predetermined time period, and determines whether the amount of change is within a predetermined threshold. When the amount of change is within the threshold, control proceeds to step 300 and start the process from the beginning because there is no adjustments needed. Otherwise, control proceeds to step 312.

In step 312, the adjustment unit 10 adjusts at least one furnace parameter based on the evaluation of the images, the plurality of signals, and the 3D radiance or temperature field for controlling the conditions of the combustion process in the enclosure. More specifically, the adjustment unit 10 controls at least one actuator associated with the enclosure 12 based on the at least one adjusted furnace parameter. A burner setting associated with an individual burner of the enclosure is modulated based on the computed amount of change For example, the adjustment unit 10 regulates at least one burner of the enclosure 12 based on the at least one adjusted furnace parameter during the combustion process. The process ends at step 314.

While a particular embodiment of the present process has been described herein, it will be appreciated by those skilled in the art that changes and modifications may be made thereto without departing from the invention in its broader aspects and as set forth in the following claims.

What is claimed is:

1. A process for diagnosing conditions of a combustion process in an enclosure, comprising:
capturing images of selected regions of the enclosure using a plurality of image-capturing devices connected to the enclosure;
receiving a plurality of signals representing the conditions of the combustion process from at least one sensor associated with the enclosure;
estimating a three-dimensional (3D) radiance or temperature field of the combustion process in the selected regions;
evaluating the captured images, the plurality of signals, and the 3D radiance or temperature field for analyzing the conditions of the combustion process at a predetermined interval; and
adjusting at least one furnace parameter based on the evaluation of the images, the plurality of signals, and the 3D radiance or temperature field for controlling the conditions of the combustion process in the enclosure.

2. The process according to claim 1, further comprising detecting flame impingement or temperatures associated with components of the enclosure based on at least one of: the captured images, the plurality of signals, and the 3D radiance or temperature field.

3. The process according to claim 1, wherein each sensor detects an operational status of a corresponding component of the enclosure.

4. The process according to claim 1, further comprising controlling at least one actuator associated with the enclosure based on the at least one adjusted furnace parameter

5. The process according to claim 1, further comprising regulating at least one burner of the enclosure based on the at least one adjusted furnace parameter during the combustion process.

6. The process according to claim 1, further comprising computing an amount of change in the at least one furnace parameter during a predetermined time period.

7. The process according to claim 6, further comprising modulating a burner setting associated with an individual burner of the enclosure based on the computed amount of change.

8. An apparatus for diagnosing conditions of a combustion process in an enclosure, the apparatus comprising:
an adjustment unit configured for:
capturing images of selected regions of the enclosure using a plurality of image-capturing devices connected to the enclosure;
receiving a plurality of signals representing the conditions of the combustion process from at least one sensor associated with the enclosure;
estimating a three-dimensional (3D) radiance or temperature field of the combustion process in the selected regions;
evaluating the captured images, the plurality of signals, and the 3D radiance or temperature field for analyzing the conditions of the combustion process at a predetermined interval; and
adjusting at least one furnace parameter based on the evaluation of the images, the plurality of signals, and the 3D radiance or temperature field for controlling the conditions of the combustion process in the enclosure.

9. The apparatus according to claim 8, wherein the adjustment unit is configured for detecting flame impingement or temperatures associated with components of the enclosure based on at least one of: the captured images, the plurality of signals, and the 3D radiance or temperature field.

10. The apparatus according to claim 8, wherein each sensor detects an operational status of a corresponding component of the enclosure.

11. The apparatus according to claim 8, wherein the adjustment unit is configured for controlling at least one actuator associated with the enclosure based on the at least one adjusted furnace parameter.

12. The apparatus according to claim 8, wherein the adjustment unit is configured for regulating at least one burner of the enclosure based on the at least one adjusted furnace parameter during the combustion process.

13. The apparatus according to claim 8, wherein the adjustment unit is configured for computing an amount of change in the at least one furnace parameter during a predetermined time period.

14. The apparatus according to claim 13, wherein the adjustment unit is configured for modulating a burner setting associated with an individual burner of the enclosure based on the computed amount of change.

15. A non-transitory computer-readable medium storing instructions executable by a computer processor to diagnose conditions of a combustion process in an enclosure, comprising instructions to:
capture images of selected regions of the enclosure using a plurality of image-capturing devices connected to the enclosure;
receive a plurality of signals representing the conditions of the combustion process from at least one sensor associated with the enclosure:
estimate a three-dimensional (3D) radiance or temperature field of the combustion process in the selected regions;
evaluate the captured images, the plurality of signals, and the 3D radiance or temperature field for analyzing the conditions of the combustion process at a predetermined interval; and
adjust at least one furnace parameter based on the evaluation of the images, the plurality of signals, and the 3D radiance or temperature field for controlling the conditions of the combustion process in the enclosure.

16. The medium according to claim 15, further comprising instructions to detect flame impingement or temperatures associated with components of the enclosure based on at least one of: the captured images, the plurality of signals, and the 3D radiance or temperature field.

17. The medium according to claim 15, further comprising instructions to perform that each sensor detects an operational status of a corresponding component of the enclosure.

18. The medium according to claim 15, further comprising instructions to control at least one actuator associated with the enclosure based on the at least one adjusted furnace parameter.

19. The medium according to claim 15, further comprising instructions to regulate at least one burner of the enclosure based on the at least one adjusted furnace parameter during the combustion process.

20. The medium according to claim 15, further comprising instructions to compute an amount of change in the at least one furnace parameter during a predetermined time period, and modulate a burner setting associated with an individual burner of the enclosure based on the computed amount of change.
